(19) United States
(12) Patent Application Publication
(10) Pub. No.: US 2024/0072326 A1
(43) Pub. Date: Feb. 29, 2024

(54) DUCT BODY AND VEHICLE

(71) Applicant: TOYOTA JIDOSHA KABUSHIKI KAISHA, Toyota-shi (JP)

(72) Inventor: Yuya KUMASAKA, Toyota-shi (JP)

(73) Assignee: TOYOTA JIDOSHA KABUSHIKI KAISHA, Toyota-shi (JP)

(21) Appl. No.: 18/449,076

(22) Filed: Aug. 14, 2023

(30) Foreign Application Priority Data
Aug. 25, 2022 (JP) 2022-133865

(51) Int. Cl. H01M 10/625; B60K 11/06; H01M 10/613; H01M 10/6566

(52) U.S. Cl. CPC H01M 10/625; B60K 11/06; H01M 10/613; H01M 10/6566

(57) ABSTRACT

The present disclosure provides a duct body for supplying cooling air toward a heating element, wherein the duct body has an upstream duct and a downstream duct, the duct body has an overlapping region in which the upstream duct and the downstream duct overlap, and in the overlapping region, the upstream duct is disposed outside the downstream duct via an air layer, the downstream duct has a convex portion on a surface on the upstream duct side, the upstream duct has a concave portion on a surface on the downstream duct side, and the overlapping region has a fitting structure in which at least a part of the convex portion fits with the concave portion, and has a heat insulating structure having the air layer on an upstream side of the fitting structure.

### TECHNICAL FIELD

The present disclosure relates to a duct body and a vehicle.

### BACKGROUND ART

A duct body that supplies cooling air toward a heating element such as a battery is known. Patent Literature 1 discloses a duct structure having a duct body and a heat insulating member. In particular, Patent Literature 1 discloses the formation of an air layer by covering a concave portion of a duct with a heat insulating member. In addition, Patent Literature 2 discloses a duct structure including a power supply pack, a blower, and a duct. In addition, Patent Literature 3 discloses a battery-cooling structure having a battery, an intake duct, and a partition panel.

### CITATION LIST

### Patent Literatures

Patent Literature 1: Japanese Patent Application Laid-Open (JP-A) No. 2008-201371
Patent Literature 2: JP-A No. 2009-040152
Patent Literature 3: JP-A No. 2009-012606

### SUMMARY OF DISCLOSURE

### Technical Problem

As described above, in Patent Literature 1, it is disclosed that an air layer is formed by covering a concave portion of a duct body with a heat insulating member. When the heat insulating member is used, the air layer can be easily formed. On the other hand, by using the heat insulating member, the number of components increases.

An object of the present disclosure is to provide a duct body having a good heat insulating property and suppressing an increase in the number of components.

### Solution to Problem

[1]

A duct body for supplying cooling air toward a heating element, wherein the duct body has an upstream duct and a downstream duct, the duct body has an overlapping region in which the upstream duct and the downstream duct overlap, and in the overlapping region, the upstream duct is disposed outside the downstream duct via an air layer, the downstream duct has a convex portion on a surface on the upstream duct side, the upstream duct has a concave portion on a surface on the downstream duct side, and the overlapping region has a fitting structure in which at least a part of the convex portion fits with the concave portion, and has a heat insulating structure having the air layer on an upstream side of the fitting structure.

[2]

The duct body according to [1], wherein at least one of the upstream duct and the downstream duct has a projection portion configured to form the air layer.

[3]

The duct body according to [1] or [2], wherein the upstream duct has an enlarged opening portion at a downstream end, and an inner diameter of the enlarged opening portion is larger than an inner diameter of the upstream duct in the heat insulating structure.

[4]

The duct body according to any one of [1] to [3], wherein the upstream duct has an enlarged opening portion at a downstream end, an inner diameter of the enlarged opening portion is larger than an inner diameter of the upstream duct in the heat insulating structure, the upstream duct and the downstream duct are resin ducts, and the heating element is a battery.

[5]

A vehicle comprising the duct body according to [4], wherein the vehicle mounts the heating element behind a seat, and the vehicle is a hybrid electric vehicle or a plug-in hybrid electric vehicle.

### Advantageous Effects of Disclosure

The duct body according to the present disclosure has a good heat insulating property and can suppress an increase in the number of components.

### BRIEF DESCRIPTION OF DRAWINGS

FIG. 1A is a schematic perspective view illustrating an upstream duct and a downstream duct, the FIG. 1B is a schematic perspective view illustrating a duct body, the FIG. 1C is a cross-sectional view of A-A line of FIG. 1B.

FIG. 2A is a schematic perspective view illustrating an upstream duct and a downstream duct, the FIG. 2B is a schematic perspective view illustrating a duct body, the FIG. 2C is a cross-sectional view of A-A line of FIG. 2B.

FIG. 3 is a schematic cross-sectional view illustrating a duct body in the present disclosure.

FIG. 4 is a schematic perspective view illustrating a downstream duct in the present disclosure.

FIG. 5A is a schematic side view illustrating a portion of a vehicle in the present disclosure, FIG. 5B is a schematic rear view illustrating a portion of the vehicle in the present disclosure, and FIG. 5C is a schematic top view illustrating a portion of the vehicle in the present disclosure.

### DESCRIPTION OF EMBODIMENTS

Hereinafter, the present disclosure will be described in detail with reference to the drawings. The figures shown below are examples, and the size of each part and the shape of each part may be exaggerated for ease of understanding.

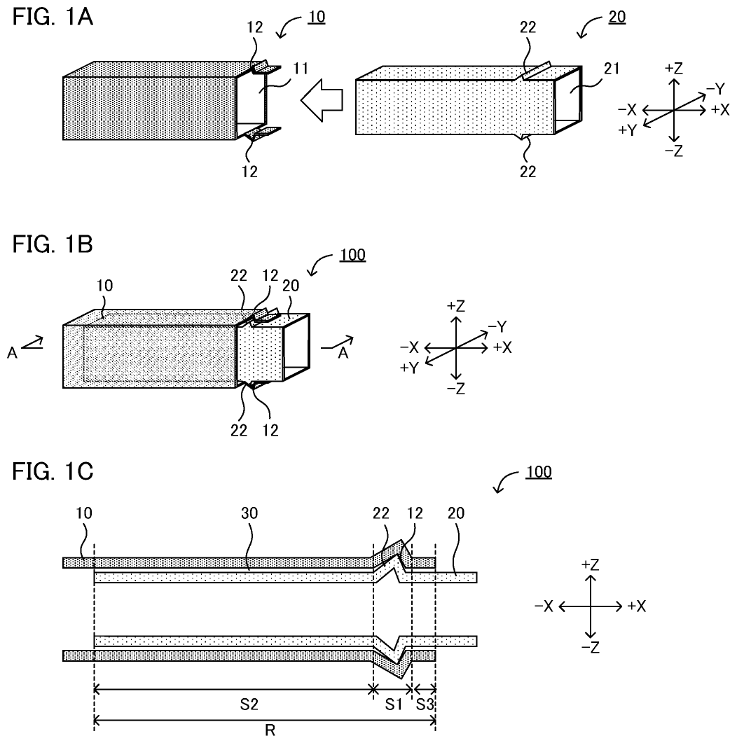

FIG. 1A is a schematic perspective view illustrating an upstream duct and a downstream duct, FIG. 1B is a schematic perspective view illustrating a duct body, FIG. 1C is a cross-sectional view of A-A line of 1B. As shown in FIG. 1A and FIG. 1B, the duct body 100 has an upstream duct 10 and a downstream duct 20. As shown in 1C, the duct body 100 has an overlapping region R in which the upstream duct 10 and the downstream duct 20 overlap.

In the overlapping region R, an upstream duct 10 is arranged outside the downstream duct 20 via the air layer 30. Further, in the overlapping region R, the downstream duct 20 has a convex portion 22 on the surface of the upstream duct 10 side, and the upstream duct 10 has a concave portion 12 on the surface of the downstream duct 20 side. The overlapping region R has a fitting structure S1 in which at least a part of the convex portion 22 is fitted into the concave portion 12. Further, the overlapping region R has a heat insulating structure S2 having an air layer upstream of the fitting structure S1.

The duct body in the present disclosure has a fitting structure and a heat insulating structure. Therefore, the duct body according to the present disclosure has a good heat insulating property and can suppress an increase in the number of components. As described above, in Patent Literature 1, it is disclosed that an air layer is formed by covering a concave portion of a duct body with a heat insulating member. By using the heat insulating member, an air layer can be easily formed. On the other hand, when the heat insulating member is used, the number of components increases.

In contrast, in the present disclosure, an upstream duct and a downstream duct are used to form an air layer. Therefore, a good heat insulating property can be obtained without using a heat insulating member (that is, a member having only a heat insulating function). Further, since it is not necessary to use a heat insulating member, an increase in the number of components is suppressed. In addition, since the number of components is small, the environmental load at the time of recycling is small.

In Patent Literature 1, the concave portion of the duct body is covered with a heat insulating member to form an air layer. Therefore, the air layer is locally formed. In contrast, the air layer in the present disclosure is uniformly formed. Specifically, an air layer is formed so as to cover the entire outer edge of the downstream duct in the flow direction of the cooling air. Therefore, a good heat insulating property can be obtained.

For example, in a hybrid electric vehicle (HEV) having FR (Front engine Rear drive) system, a propeller shaft is arranged in the center of the vehicle. Therefore, battery (driving battery) is often mounted in a cargo compartment located on the rear side of the vehicle. Also, cooled airs in the passenger cabin may be utilized to cool battery. In this case, the length of the duct body connecting the intake port arranged in the passenger cabin and battery mounted in the luggage compartment located in the rear side of the vehicle is increased. Therefore, a plurality of ducts may be connected to form a duct body.

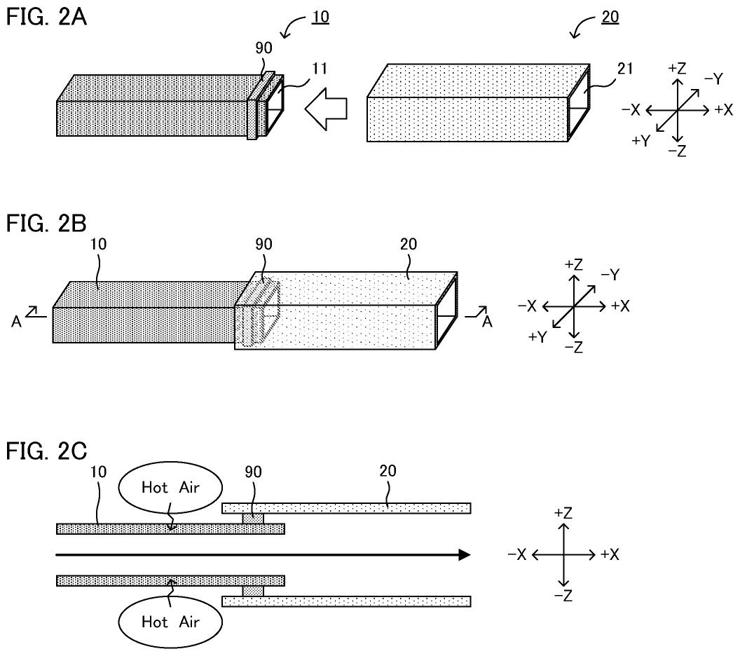

As shown in FIGS. 2A, 2B, and 2C, it is assumed that the sponge portion 90 is provided at the downstream end portion of the upstream duct 10, and the upstream duct 10 and the downstream duct 20 are connected via the sponge portion 90. The temperature of the cooling air flowing through the inside of the duct body is increased by the heat received from the outside of the duct body. Therefore, as the length of the duct body increases (as the surface area of the duct body increases), the temperature of the cooling air flowing through the inside of the duct body also increases.

In order to suppress the influence of heat received from the outside of the duct body, it is effective to provide the above-described air layer (heat insulating layer). However, as described above, when the heat insulating member is used, the number of components increases, and as a result, the cost increases. In contrast, in the present disclosure, since the air layer is formed by using the upstream duct and the downstream duct, an increase in the number of components is suppressed.

Further, since the sponge portion is soft, there is a problem that it is difficult for an operator to confirm whether or not the upstream duct and the downstream duct are accurately connected. In contrast, the duct body in the present disclosure has a fitting structure. Therefore, there is an advantage that it is easy for an operator to confirm whether or not the upstream duct and the downstream duct are accurately connected.

### 1. Upstream Duct

The upstream duct in the present disclosure is disposed upstream of the downstream duct in the flow direction of the cooling air. In the present disclosure, the flow direction of the cooling air is defined as the +X direction. Further, in the present disclosure, “upstream side” means −X direction side, and “downstream side” means the +X direction side.

The upstream duct in the present disclosure is a hollow member. As shown in the FIG. 1A, the upstream duct 10 has an opening portion 11. In FIG. 1A, opening portion 11 extends along the X-axis. The shape of the outer edge of the upstream duct in the X-axis direction is not particularly limited. Examples of the outer edge shape of the upstream duct include a quadrangular shape, a circular shape, and an oval shape.

The inner diameter of the upstream duct may increase continuously in the flow direction of the cooling air. In addition, the inner diameter of the upstream duct may continuously decrease in the flow direction of the cooling air. The upstream duct is, for example, a resin duct. That is, the upstream duct may be a resin molded product. Examples of the method for forming the upstream duct include blow molding and injection molding.

### 2. Downstream Duct

The downstream duct in the present disclosure is disposed downstream of the upstream duct in the flow direction of the cooling air. The downstream duct is a hollow member. As shown in the FIG. 1A, the downstream duct 20 has an opening portion 21. In FIG. 1A, opening portion 21 extends along the X-axis. The outer edge shape of the downstream duct in the X-axis direction is not particularly limited. Examples of the outer edge shape of the downstream duct include a quadrangular shape, a circular shape, and an oval shape. The outer edge shape of the downstream duct may be a similar shape of the outer edge shape of the upstream duct.

The inner diameter of the downstream duct may increase continuously in the flow direction of the cooling air. In addition, the inner diameter of the downstream duct may continuously decrease in the flow direction of the cooling air. The downstream duct is, for example, a resin duct. That is, the downstream duct may be a resin molded article. Examples of the method for forming the downstream duct include blow molding and injection molding.

### 3. Duct Body

The duct body in the present disclosure has an overlapping region in which the upstream duct and the downstream duct overlap. As shown in FIG. 1C, the duct body 100 has an overlapping region R in which the upstream duct 10 and the downstream duct 20 overlap. As shown in FIGS. 1A and 1B, an overlapping region R is formed by inserting the upstream end of the downstream duct 20 into opening portion 11 located at the downstream end of the upstream duct 10. As shown in FIG. 1C, the overlapping region R is preferably a linear region along the X-axis. On the other hand, the overlapping region R may be a curved region.

As shown in FIG. 1C, the downstream duct 20 has a convex portion 22 on the upstream duct 10. Similarly, the upstream duct 10 has a concave portion 12 on the surface on the downstream duct 20 side. The overlapping region R has a fitting structure S1 in which at least a part of the convex portion 22 is fitted into the concave portion 12. Further, the overlapping region R has a heat insulating structure S2 upstream of the fitting structure S1. The heat insulating structure S2 has an air layer 30 between the upstream duct 10 and the downstream duct 20.

As shown in FIG. 1C, the upstream duct 10 has a concave portion 12 on the side of the downstream duct 20. The upstream duct 10 in FIG. 1C has a protruding portion protruding in the +Z direction. The surface of the protruding portion on the downstream duct 20 side corresponds to the concave portion 12. Further, the upstream duct 10 in FIG. 1C has a protruding portion protruding in the −Z direction. The surface of the protruding portion on the downstream duct 20 side corresponds to the concave portion 12. In this way, the upstream duct 10 may have a plurality of concave portions 12.

As shown in the FIGS. 1A and 1B, the upstream duct 10 may have two concave portions 12 arranged to face each other in one axial direction. In the FIGS. 1A and 1B, two concave portions 12 are arranged opposite each other in the Z-axis direction. Further, as shown in FIGS. 1A and 1B, the upstream duct 10 may have a surface on which the concave portion 12 is not disposed. In the FIGS. 1A and 1B, the upstream duct 10 has no concave portion in the two faces facing each other in the Y-axis direction.

As shown in FIGS. 1A, 1B, and 1C, the downstream duct 20 has a convex portion 22 on the side of upstream duct 10. The downstream duct 20 has a convex portion 22 so as to correspond to the position of the concave portion 12 of the upstream duct 10.

As shown in the FIG. 1C, the overlapping region R has a fitting structure S1, an insulating structure S2 and an insulating structure S3. In the fitting structure S1, at least a portion of the convex portion 22 is fitted into the concave portion 12. That is, the relative movement of the upstream duct 10 and the downstream duct 20 in the X-axis direction is limited by the fitting of the convex portion 22 and the concave portion 12. Further, the heat insulating structure S2 includes the air layer 30 and is disposed upstream of the fitting structure S1. On the other hand, the heat insulating structure S3 has an air layer 30 and is disposed downstream of the fitting structure S1.

Let LR be the length of the overlapping region R, let LS1 be the length of the fitting structure S1, let LS2 be the length of the heat insulating structure S2, and let LS3 be the length of the heat insulating structure S3. Each of these lengths corresponds to a length in the X-axis direction. LR is, for example, 10 cm or more, may be 30 cm or more, may be 50 cm or more, or may be 100 cm or more. Meanwhile, the upper limit of LR is not particularly limited. LS1 is, for example, equal to or greater than 1 cm and equal to or less than 10 cm.

LS2 is, for example, 10 cm or more, may be 30 cm or more, may be 50 cm or more, or may be 100 cm or more. Meanwhile, the upper limit of LS2 is not particularly limited. The ratio (LS2/LR) of LS2 to LR is, for example, 30% or more, may be 50% or more, or may be 70% or more. On the other hand, LR2/LR is 90% or less, for example.

LS3 is, for example, equal to or greater than 1 cm, may be equal to or greater than 5 cm, or may be equal to or greater than 10 cm. On the other hand, LS3 is, for example, 30 cm or less. If LS3 is too short, the fitting structure S1 may be less stable. On the other hand, if LS3 is too long, the upstream duct and the downstream duct may be damaged when forming the fitting structure S1.

The thickness (length in the Z-axis direction) of the air layer 30 is not particularly limited, but is, for example, equal to or greater than 1 mm and equal to or less than 10 mm. If the air layer 30 is too thin, sufficient insulation may be obtained. On the other hand, if the air layer 30 is too thick, the flow rate of the cooling air for cooling the heating element may decrease.

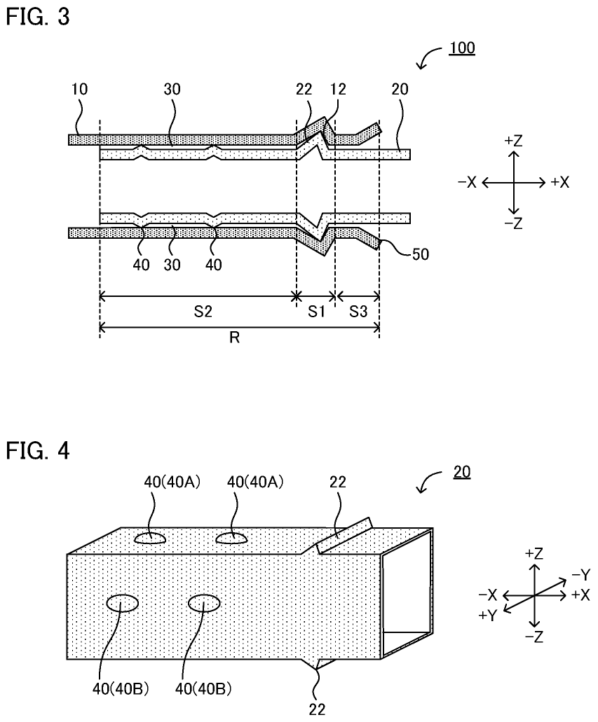

In the heat insulating structure, at least one of the upstream duct and the downstream duct preferably has a projection portion configured to form an air layer. The downstream duct 20 shown in FIG. 3 has a projection portion 40 on the surface on the upstream duct 10 side. When the projection portion 40 of the downstream duct 20 comes into contact with the upstream duct 10, the air layer 30 is formed between the downstream duct 20 and the upstream duct 10. Further, although not shown, the upstream duct may have a projection portion on the surface on the downstream duct side.

As shown in FIG. 4, in the downstream duct 20, the projection portion 40A may be disposed on a surface where the convex portion 22 is disposed. In FIG. 4, the projection portion 40A has a dot-like shape. Further, although not particularly illustrated, in the downstream duct, the projecting portion may not be disposed on the surface where the convex portion is disposed. Further, as shown in FIG. 4, in the downstream duct 20, the projection portion 40B may be disposed on a surface where the convex portion 22 is not disposed.

Projection portions may be arranged on all surfaces constituting the outer edge shape of the downstream duct in the X-axis direction. For example, in FIG. 4, the outer edge shape of the downstream duct 20 in the X-axis direction is a quadrangle. projection portions 40 may be arranged on all surfaces constituting the quadrangle.

The shape of the projection portion in a plan view is not particularly limited. Examples of the shape of the projection portion include a circle, an ellipse, and a polygon. The projection portion may extend parallel to the X-axis direction. In this case, workability is improved when the downstream duct is inserted into the upstream duct. On the other hand, in a cross section perpendicular to the X-axis direction, the projection portion may be disposed on the entire circumference of the outer edge of the downstream duct. On the other hand, in a cross section perpendicular to the X-axis direction, the projection portion may not be disposed on the entire circumference of the outer edge of the downstream duct.

The upstream duct may have an enlarged opening portion at its downstream end. The upstream duct 10 shown in FIG. 3 has an enlarged opening portion 50 at the downstream side (+X direction side) end. The inner diameter of the enlarged opening portion 50 is greater than the inner diameter of the upstream duct 10 in the heat insulating structure S2.

The enlarged opening portion 50 serves as a guide when the downstream duct 20 is inserted into the upstream duct 10. Therefore, the workability of inserting the downstream duct 20 into the upstream duct 10 is improved. The inner diameter of the enlarged opening portion 50 is taken as I1, and the mean inner diameter of the upstream ducting 10 in the heat insulating structure S2 is taken as I2. The ratio (I1/I2) of I1 to I2 is, for example, 1.05 or more, and may be 1.10 or more. I1/I2 is, for example, 1.50 or less.

The duct body in the present disclosure is a duct body for supplying cooling air toward the heating element. The type of the heating element is not particularly limited. Examples of the heating element include battery. Examples of battery include nickel-hydrogen battery and lithium-ion battery.

The use of the duct body is not particularly limited. The duct body is preferably mounted on the moving body. Examples of the moving body include a vehicle, a railroad, a ship, and an aircraft. Examples of the vehicle include a motor vehicle. The motor vehicle is preferably a hybrid electric vehicle (HEV) or a plug-in hybrid electric vehicle (PHEV). It is also preferred that the motor vehicle has FR (Front engine Rear drive) system.

### B. Vehicle

The present disclosure provides a vehicle equipped with the above-described duct body.

A vehicle according to the present disclosure is equipped with the above-described duct body. Therefore, the vehicle according to the present disclosure can satisfactorily supply the cooling air toward the heating element. The duct body, the heating element, and the vehicles are the same as those described in the “A. duct body”.

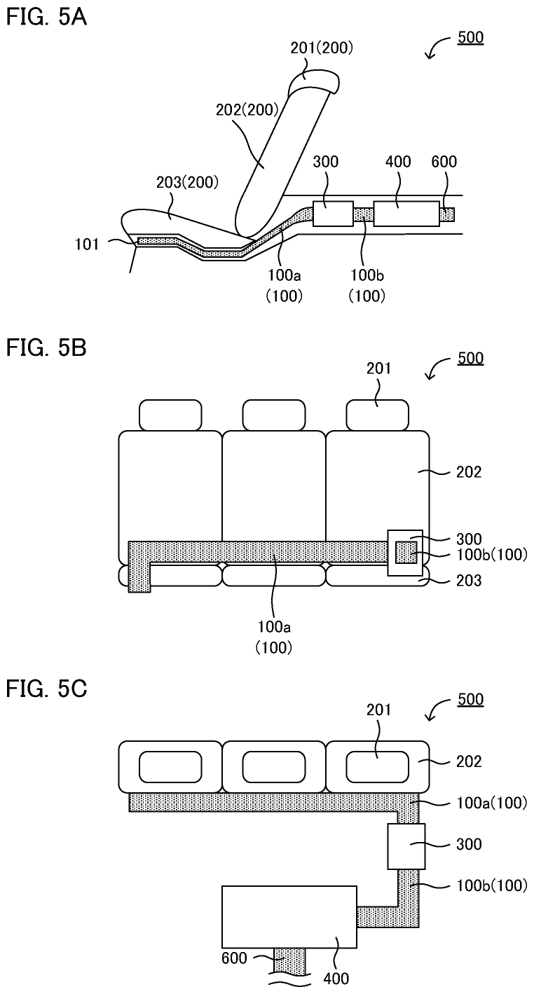

FIG. 5A is a schematic side view illustrating a portion of a vehicle in the present disclosure, FIG. 5B is a schematic rear view illustrating a portion of the vehicle in the present disclosure, and FIG. 5C is a schematic top view illustrating a portion of the vehicle in the present disclosure. In the FIG. 5B, battery is omitted.

As shown in the FIGS. 5A, 5B, and 5C, the vehicles 500 mount battery 400, which is a heating element, on the rear side of the seat 200. Battery 400 supplies electric power to a motor (driving motor) mounted on the vehicles. Specifically, the DC current discharged from battery 400 is converted into an AC current by an inverter, and the AC current is supplied to the motor. On the other hand, when energy regeneration is performed, an alternating current generated by a motor is converted into a direct current by an inverter, and the direct current is charged into battery 400.

The seat 200 shown in the FIGS. 5A, 5B, and 5C has a headrest portion 201, a backrest portion 202, and a seat portion 203. In the FIGS. 5A, 5B and 5C, the seat 200 is a rear seat and battery 400 is mounted on the bottom of the luggage compartment.

The vehicle 500 includes the duct body 100 described above. The duct body 100 includes an air inlet 101. The air inlet 101 is located in the vehicle interior on the passenger compartment side. The air inlet 101 shown in 5A is located at the foot of the seat 200. The duct body 100 connects the air inlet 101 and battery 400. The cooling air sucked from the air inlet 101 is supplied to battery 400 via the duct body 100.

As shown in 5A, a blower 300 may be disposed between the air inlet 101 and battery 400. In this instance, the vehicles 500 have a duct body 100a and a duct body 100b. The duct body 100a connects the air inlet 101 and the blower 300, and the duct body 100b connects the blower 300 and battery 400. Preferably, at least one of the duct body 100a and the duct body 100b is the duct body 100 having the fitting structure and the heat insulating structure.

As shown in FIG. 5B, the duct body 100 preferably has a widthwise extending region of the vehicle. In such a region, it is easy to install a linear overlapping region R. Further, as shown in FIG. 5A, the vehicles 500 may include an exhaust-duct 600 downstream of battery 400.

### REFERENCE SINGS LIST

10 Upstream duct
20 Downstream duct
30 Air layer
100 Duct body
200 Sheet
300 Blower
400 Battery
500 Vehicle

What is claimed is:

1. A duct body for supplying cooling air toward a heating element, wherein the duct body has an upstream duct and a downstream duct, the duct body has an overlapping region in which the upstream duct and the downstream duct overlap, and in the overlapping region, the upstream duct is disposed outside the downstream duct via an air layer, the downstream duct has a convex portion on a surface on the upstream duct side, the upstream duct has a concave portion on a surface on the downstream duct side, and the overlapping region has a fitting structure in which at least a part of the convex portion fits with the concave portion, and has a heat insulating structure having the air layer on an upstream side of the fitting structure.

2. The duct body according to claim 1, wherein at least one of the upstream duct and the downstream duct has a projection portion configured to form the air layer.

3. The duct body according to claim 1, wherein the upstream duct has an enlarged opening portion at a downstream end, and an inner diameter of the enlarged opening portion is larger than an inner diameter of the upstream duct in the heat insulating structure.

4. The duct body according to claim 2, wherein the upstream duct has an enlarged opening portion at a downstream end, an inner diameter of the enlarged opening portion is larger than an inner diameter of the upstream duct in the heat insulating structure, the upstream duct and the downstream duct are resin ducts, and the heating element is a battery.

5. A vehicle comprising the duct body according to claim 4, wherein the vehicle mounts the heating element behind a seat, and the vehicle is a hybrid electric vehicle or a plug-in hybrid electric vehicle.
